(19) United States
(12) Patent Application Publication
(10) Pub. No.: US 2005/0252679 A1
(43) Pub. Date: Nov. 17, 2005

(54) Multi-layer insulated wire, processes for preparing the same, and its applications

(76) Inventors: Hsing-Hua Chang, Taipei (TW); Mario A. Perez, Burnsville, MN (US); C. Carol Guilbert, Austin, TX (US)

Correspondence Address: 3M INNOVATIVE PROPERTIES COMPANY, PO BOX 33427, ST. PAUL, MN, 55133-3427, US

(21) Appl. No.: 10/844,959

(22) Filed: May 13, 2004

(51) Int. Cl. H01B 7/00

(52) U.S. Cl. 174/120 R; 174/110 R

(57) ABSTRACT

Disclosed is a multi-layer insulated wire comprising a conductor and one or more insulating layers covering the conductor, wherein the one or more insulating layers are prepared from a composition comprising: (A) 100 parts by weight of a thermoplastic polyester-series resin, and (B) from 1 to 70 parts by weight of an ethylene-series polymer having epoxy and acrylate groups. Also disclosed are a process for preparing the multi-layer insulated wire and electronic devices, such as transformers, comprising the multi-layer insulated wire.

### FIELD

The present invention relates to a multi-layer insulated wire.

### BACKGROUND

Transformers having a construction meeting the requirements prescribed by IEC 60950 and UL 60950 Standards are known. A traditional transformer 11 comprising an insulating tape 12 and an insulating barrier 13 in its structure is shown in FIG. 1 of the subject application.

However, the use of insulating barriers and insulating tapes in the structures of such traditional transformers is complicated and time-consuming during processing, which leads to the decrease of productivity.

Recently, a transformer having a structure including an insulated wire rather than insulating barriers (or, margin thickeners) or insulating tapes has been used in substitution for the conventional transformer aforementioned. Flexibility is especially important to the application of insulated wires. If the flexibility of insulated wires is poor, it will damage the structure and the electrical properties of the electronic devices comprising the insulated wires.

### SUMMARY

Given the above, there is still a need for a multi-layer insulated wire, which has good flexibility, coilability, twistability, and wide-environmental conditions capability.

One aspect of the present invention relates to a multi-layer insulated wire comprising a strand of conductive material, referred to herein as a conductor or a conductor strand, and one or more insulating layers covering the conductor strand, wherein at least one of the insulating layers is made of a composition comprising:
(A) about 100 parts by weight of a thermoplastic polyester-series resin, and
(B) from about 1 to about 70 parts by weight of an ethylene-series polymer having at least one epoxy and at least one acrylate group.

Another aspect of the invention relates to a process for preparing a multi-layer insulated wire comprising:

Applying onto the conductor strand a composition comprising 100 parts by weight of (A) a thermoplastic polyester-series resin and from 1 to 70 parts by weight of (B) an ethylene-series polymer having epoxy and acrylate groups, and, optionally, from (C) one or more additives.

Another aspect of the invention relates to a process for preparing a multi-layer insulated wire comprising:
(a) providing a conductor strand;
(b) blending a composition comprising 100 parts by weight of (A) a thermoplastic polyester-series resin and from 1 to 70 parts by weight of (B) an ethylene-series polymer having epoxy and acrylate groups, and, optionally, from (C) one or more additives; and
(c) applying the composition of step (b) onto the conductor strand.

Other aspects of the present invention relate to electronic devices, such as transformers, containing the insulated wire.

The multi-layer insulated wire of the present invention is flexible, coilable, twistable, and suitable for use in a wide range of wide-environmental conditions. For example, the insulated wire may be used over a wide range of ambient temperatures and relative humidities. Electronic devices including the multi-layer insulated wire of the present invention in their structures, such as transformers and capacitors, have electrical properties meeting IEC 60950 and UL 60950 standards, and are highly reliable.

These aspects of the present invention will be fully understood and appreciated by the description in the written specification.

As used in this application:
“polyester-series” means any thermoplastic straight-chain polyester resin obtained by an esterification reaction between aliphatic diol and an aromatic dicarboxylic acid or a dicarboxyic acid obtained by replacing part of the aromatic dicarboxylic acid with an aliphatic dicarboxylic acid; the polyester resin may be a copolymer and may be substituted or unsubstituted;
“ethylene-series” means an ethylene-based material having at least one epoxy group and at least one acrylate group; the ethylene-based material may be a polymer, co-polymer, terpolymer, and may be substituted or unsubstituted; and
“self-bonding resin” means a resin formed into layers, which layers are capable of fusing together upon the application of heat or solvent.

### BRIEF DESCRIPTION OF DRAWINGS

FIG. 1 is a cross-sectional view of a traditional transformer having a structure in which insulating barriers and insulating tapes are used.

FIG. 2 shows an embodiment of the multi-layer insulated wire of the present invention.

FIG. 3 is a cross-sectional view of a transformer comprising an exemplary multi-layer insulated wire of the present invention.

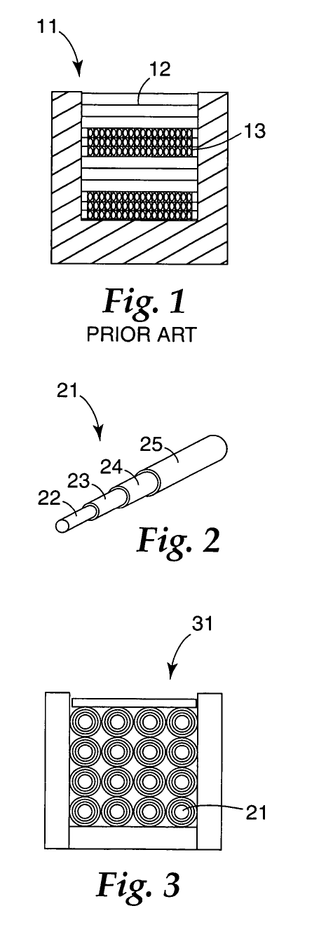

### DETAILED DESCRIPTION OF THE INVENTION

The present invention provides a multi-layer insulated wire comprising a conductor and one or more insulating layers covering the conductor, wherein at least one insulating layer is made of a composition comprising:
(A) about 100 parts by weight of a thermoplastic polyester-series resin, and
(B) from about 1 to about 70 parts by weight of an ethylene-series polymer having at least one epoxy and at least one acrylate groups.

The thermoplastic polyester-series resins (A) may be any of those known to be useful in the manufacture of insulating materials. Examples of suitable thermoplastic polyester-series resins include polyethylene terephthalate (PET) resins, polybutylene terephthalate (PBT) resins, polybutylene naphthalate resins, polycyclohexanedimethylene resins, polyethylene naphthalate resins, and mixtures thereof. For at least one embodiment, a preferred thermoplastic polyester-series resin is a polyethylene terephthalate resin (PET).

Examples of suitable ethylene-series polymer having at least one epoxy and at least one acrylate groups (B) include ethylene/epoxy-(C₁-C₈-alkyl)acrylate polymers, ethylene/(C₁-C₈-alkyl)acrylate/epoxy-(C₁-C₈-alkyl)acrylate terpolymers, and/or mixtures thereof. For at least one embodiment, a preferred ethylene-series polymer (B) may be ethylene/epoxy-(C₁-C₄-alkyl)acrylatepolymers, ethylene/(C₁-C₄-alkyl)acrylate/epoxy-(C₁-C₄-alkyl)acrylate terpolymers, and/or mixtures thereof. A suitable ethylene acrylic ester terpolymer may have a methyl, ethyl or butyl acrylate, and may use as a third monomer maleic anhydride (MAH) or glycidyl methacrylate (GMA). A suitable ethylene-series polymer is a terpolymer of ethylene, butylacrylate (BA) and glycidylmethacrylate (E/nBA/GMA) available from DuPont Packaging & Industrial Polymers, Wilmington, Del., under the trade designation ELVALOY.

The ethylene-series polymer (B) is used in an amount of from about 1 to about 70 parts by weight based on 100 parts by weight of the thermoplastic polyester-series resin (A). In some embodiments, the ethylene-series polymer (B) is used in an amount of from about 1 to about 50 parts by weight based on 100 parts by weight of the thermoplastic polyester-series resin (A).

The conductor in the present invention may be a bare strand of metal (solid conductor), an insulated conductive strand having an enamel film or a thin insulating layer coated on a bare metal strand, a multi-core stranded conductor (a group of metal strands) composed of intertwined bare metal strands, or a multi-core stranded conductor composed of intertwined insulated-strands that each have an enamel film or a thin insulating layer coating. Suitable metal strands include copper and aluminum strands.

The composition according to the present invention may also contain one or more additives (C) commonly used in the art, in such amounts that they do not impair the action and effects to be attained according to the present invention but result in the desired, additional benefits. Suitable amounts are typically in the range of up to about 40 parts by weight. Additives may be those selected from colorants, fillers, binders, coupling agents, aluminum hydroxides, and process additives, such as ethylene-butyl acrylate (EBA) copolymers and ethylene-methyl acrylate (EMA) copolymers, available under the trade designation LOTRYL from Atofina Company, Philadelphia, Pa. Among the above, colorants, inorganic fillers, aluminum hydroxides, and process additives are preferred, for example, because the colorants allow color-coding for easy wire type recognition, inorganic fillers can provide high impact strength and/or high deformation temperature, aluminum hydroxides can provide flame retardancy, and processing additives can allow for easier extrusion. Suitable inorganic fillers for the present invention may be, for example, titanium oxide, silica, alumina, zirconium oxide, barium sulfate, calcium carbonate, clay, talc, and the like.

The multi-layer insulated wire of the present invention may also comprise a primer between the conductor and the first of one or more insulating layers, which is the layer closest to the conductor. The presence of the primer may increase the adhesion of the one or more insulating layers to the conductor. Any materials that are known in the art to be suitable for forming a primer on an insulated conductor are applicable to the present invention. Examples include polyurethanes and acrylates.

In addition to the one or more insulating layers, the multi-layer insulated wire of the present invention may comprise an outermost layer made of material(s) that are commonly used to provide strength (i.e., toughness) to the insulated wire. Suitable examples include polyesters, polyamides, polyimides, polyphenylene sulfides, polyethersulfones, polysulfones, polycarbonates, fluoropolymers, and/or mixtures thereof. For some embodiments, polyamides are preferred for preparing the outermost layer. If desired, onto the outside of the multi-layer insulated wire of the present invention, a self-bonding resin (D) may be applied, e.g., extruded or coated, for covering, so as to form a self-bonding layer thereon. The self-bonding resin (D) is preferably applied at a low temperature or with a low-boiling solvent, because in that case the properties of the underlying insulating layer are not adversely affected. Suitable self-bonding resin (D) may be selected from a polyester resin, a polyamide resin, polyurethane, or the like.

The present invention further provides a process for preparing the multi-layer insulated wire aforementioned, which comprises applying, e.g., coating or extruding, a composition comprising about 100 parts by weight of (A) a thermoplastic polyester-series resin and from about 1 to about 70 parts by weight of (B) an ethylene-series polymer having epoxy and acrylate groups, and, optionally, from (C) one or more additives onto a conductor or wire.

The conductor may have any number of insulating layers, but three layers are most common. Each of the layers may be applied by coating or extrusion. Suitable coating methods include, e.g., dip coating.

A suitable single step process for preparing and applying the insulating material onto the conductor strand may include using a single extruder to compound the composition and apply the resulting material onto a conductor strand. This avoids the necessity of pelletizing the material and transferring it to another extruder for application to the conductor. To carry out the process in a single step, it would be preferable to use a twin-screw extruder (with a metering gear pump), the extruder having at least 5 zones, with an increasing temperature profile of about 290° C. after the feed zone to about 320° C. at the exit where material is extruded.

The present invention also provides a process for preparing the multi-layer insulated wire aforementioned, which comprises the steps of:
(a) providing a conductor strand;
(b) blending a composition comprising about 100 parts by weight of (A) a thermoplastic polyester-series resin and from about 1 to about 70 parts by weight of (B) an ethylene-series polymer having epoxy and acrylate groups, and, optionally, from (C) one or more additives; and
(c) applying the composition of step (b) onto the conductor.

The blending and application may be carried out in a single continuous process, as described above, or may be carried out in a multiple-step (typically two-step) process. A suitable two-step process may start with using a twin screw extruder to compound and pelletize the insulating material. The pellets are then introduced into another extruder (or reintroduced into the same extruder at a later time), in which the material is blended by the application of mechanical shear force as it moves through an increasing temperature profile, then the material is extruded onto the conductor strand (which may already have other layers of material applied to it). The extrusion process may include passing the conductor through the center of an annular die that dispenses the insulating material. Generally, the extrusion step is carried out using an extruder in which the temperatures of the mixing zones and die increase from about 200° C. at the first zone of the extruder to about 350° C. at the die, preferably the temperature increase is from about 200 to about 320° C.

In one aspect of the process of the present invention, step (a) may be carried out by blending the composition comprising the thermoplastic polyester-series resin (A) and the ethylene-series polymer having epoxy and acrylate groups (B) in an extruder, and then adding the additives (C) to said composition, with further mixing until a homogeneous composition is obtained. Thereafter, the resulting composition is formed into plastic pellets. Step (b) may be carried out by feeding the plastic pellets into an extruder, masticating the plastic pellets in the extruder to form a melt, and then extruding the melt onto the conductor through a die.

In this two-step process, generally, step (a) is carried out at a temperature from about 200 to about 320° C., preferably, from about 220 to about 300° C.; and step (b) is carried out at a temperature from about 200 to about 350° C., preferably, from about 200 to about 320° C.

If desired, prior to step (a), a process of the present invention may comprise step (a₁) of forming a primer (A₁), such as a benzoyl triazole, between the conductor and the one or more insulating layers, so as to increase the adhesion of the one or more insulating layers to the conductor. Any conventional techniques that are known to be applicable to the formation of a primer may be utilized in the present invention, such as dip coating and spray coating.

Step (b) of the invention may be repeated to obtain multiple layers of insulation. Multiple layers may be formed by co-extruding more than one layer in a single pass or extruding single layers in multiple passes. If the layers are applied as single layers, each layer should cool before a subsequent layer is applied.

If desired, the process of the present invention may further comprise step (c), of forming an outermost layer on the multi-layer insulated wire obtained from step (b). The outermost layer may be applied as a second, third, or other layer, over a conductor strand having at least one layer made from the composition of the present invention. Materials that are commonly used in the preparation of the outermost layer of multi-layer insulated wires are applicable to the present invention. For some embodiments, the outermost layer may be prepared from, for example, polyesters, polyamides, polyimides, polyphenylene sulfides, polyethersulfones, polysulfones, polycarbonates, fluoropolymers, and/or mixtures thereof. For some embodiments, polyamides are preferred. The outer coating is preferably flexible and resistant to high temperatures.

Moreover, the process of the present invention may further comprise step (d) of extruding a self-bonding resin (D) on the outside of the multi-layer insulated wire, so as to form a self-bonding layer thereon.

An example of a multi-layer insulated wire of the present invention is shown in FIG. 2. As shown in FIG. 2, the multi-layer insulated wire 21 comprises a conductor 22, a first insulating layer 23 covering the conductor 22, a second insulating layer 24 covering the first insulating layer 23, and an outermost layer 25 covering the second insulating layer 24. An example of the transformer 31 comprising the multi-layer insulated wire 21 of the present invention is shown in FIG. 3.

The multi-layer insulated wires of the present invention have good flexibility, coilability, and twistability, and wide-environmental conditions capability. The electronic devices comprising the multi-layer insulated wire of the present invention, such as transformers and capacitors, have electrical properties meeting IEC 60950 and UL 60950 standards, and are highly reliable.

Details of the processes of the present invention and the manner in which it can be practiced are provided in the following examples. These examples are not to be construed as a limitation of the present invention.

### EXAMPLES

Eight examples and one comparative example were made. The amounts of materials used for the layers of each example and the results of tests performed are shown in the tables below.

Specified Raw Materials

| Trade Name | Type of Material | Available From |
|---|---|---|
| ELVALOY | an ethylenic functionalized | DuPont Packaging & |
| PTW | with glycidyl methacrylate | Industrial Polymers, |
| | (epoxy functional) | Wilmington, DE |
| LOTADER | an ethylene acrylate | Atofina Company, |
| AX 8900 | terpolymer with epoxy | Philadelphia, PA |
| | functionality (glycidyl | |
| | methacrylate) | |
| FUSABOND | an ethylenic maleic anhydride | DuPont Packaging & |
| MB226D | grafted resin | Industrial Polymers, |
| | | Wilmington, DE |

Preparation
A. Material Blending

All of the components were dried prior to blending under the following conditions: the thermoplastic polyester-series resin was heated at 140° C. for 6 hours under vacuum; all of the ethylene-series polymers having at least one epoxy group and at least one acrylate group in their side chains were heated at 60° C. for 20 hours; and the inorganic fillers were heated at 140° C. for 20 hours for drying. Thereafter, all of the materials, including additives if used, were blended by using a 5-zone twin-screw extruder having a 40 mm inside diameter and then pelletized.

The temperature profile from feed to die was 200° C., 240° C., 260° C., 270° C., 280° C., 290° C., and 280° C. The screws were operated at a speed of 100 rpm.

B. Extrusion of Insulating Material onto Conductors

Examples were made using either 0.2 mm or 1.0 mm copper conductor strands. The pellets made of the above materials were fed to a single screw extruders to form melts, which were extruded onto copper conductor strands. A 20 mm diameter extruder was used for coating the insulating material onto the 0.2 mm copper conductor strand. A single screw 40 mm diameter diameter extruder was used for coating the insulating material onto the 1.0 mm copper conductor strand. The 20 mm extruder had five zones with an increasing temperature profile along the length of the extruder or 200 to 290° C. The 40 mm extruder had five zones with an increasing temperature profile along the length of the extruder or 200 to 290° C. The five zones include three heater barrel zones, one adapter heater zone, and die head heater zone.

Higher levels of ethylene-series polymer (B) modifer in the insulating material formula caused an increase in viscosity. In this case, the extruder temperature profiles and screw speeds were slightly increased to accommodate the increased viscosity and obtain good melting and mixing and excellent extrudability.

Each insulative layer was applied to the conductor (or wire) in a separate pass through the extruder.

Test Methods

A. Twisted Sample Test (UL 2353)

A straight piece of the multi-layer insulated wire, approximately 400 mm in length, was bent back on itself for a distance 125±5 mm. For the wires having a conductor diameter of 0.2 mm, the wires were twisted 33 times, then a load of 0.85 N was applied to each of the wire ends. For the wires having a conductor diameter of 1.0 mm, the wires were twisted 8 times, then a load of 13.5 N was applied to each of the wire ends. The loop at the end of the twisted section was cut at two positions to provide a maximum spacing between the cut ends. The cut ends would later be used as electrodes for the electric withstanding and breakdown tests. 6000 Vrms was applied for 60 seconds for the electric withstanding test. The test is a pass/no pass measurement. Subsequent to the electric withstanding test, an electric breakdown test is performed. For this test, increasing voltage is applied and the voltage at which the dielectric properties break down are recorded.

B. Flexibility and Adherence Test (Bending Sample, UL 2353)

A straight piece of the insulated wire, which is at least 305 mm in length, was wound for 10 continuous and adjacent turns around a polished mandrel. For an insulated wire having a 0.2 mm conductor, the mandrel diameter was 4.0+/−0.2 mm. For an insulated wire having a 11.0 mm conductor, the mandrel diameter was 10.0+/−0.2 mm. The mandrel was rotated at a rate of 1 to 3 revolutions per second (r/s) with a tension of 118 MPa applied to the wire, which was sufficient to keep it in contact with the mandrel. While the wire was still on the mandrel, 3000 Vrms were applied for the electric withstanding test.

C. Heat Shock Test: (UL 2353)

Samples of multi-layer insulated wire to be tested were prepared following the same procedure as “flexibility and adherence test.” The samples were removed from the mandrel and placed in an oven with forced air circulation at 225° C. for 30 minutes. After removing from the oven, the specimens were allowed to cool to room temperature. The wound section of wire was unwound and extended and checked for any cracks that had formed in the insulating layers. If no obvious crack was observed, 3000 Vrms was applied for the electric withstanding test.

D. Thermal Shock Test

The insulated wires to be tested were prepared as for the Twisted Sample Test and placed in a temperature control chamber at −20° C. for 30 minutes, then removed and placed in an oven at 150° C. for 30 minutes. The cycle was repeated 10 times. The electric strength of the twisted wires was evaluated, by applying 3000 Vrms for the electric withstanding test.

Results

The amounts of materials used for the layers of each example and the results of tests performed are shown in Table 1. The components amounts shown in Table 1 are parts by weight based on 100 parts by weight of the thermoplastic polyester-series resin.

TABLE 1

| Layer | Material | Ex. 1 | Ex. 2 | Ex. 3 | Ex. 4 | Ex. 5 | Ex. 6 | Ex. 7 | Ex. 8 |
|---|---|---|---|---|---|---|---|---|---|
| conductor | copper | 1.0 mm | 1.0 mm | 0.2 mm | 1.0 mm | 0.2 mm | 0.2 mm | 1.0 mm | 1.0 mm |
| | (diam.) | | | | | | | | |
| 1^{st} | PET | 100 | 100 | 100 | 100 | 100 | 100 | 100 | 100 |
| | LOTADER | — | — | 20 | 10 | — | — | — | 30 |
| | AX 8900 | | | | | | | | |
| | ELVALOY | 20 | 10 | — | 10 | 20 | 20 | 30 | — |
| | PTW | | | | | | | | |
| | FUSABOND | 10 | — | — | — | — | — | — | — |
| | MB226D | | | | | | | | |
| | Titanium | — | 2 | — | — | — | 2 | 1 | 2 |
| | Oxide | | | | | | | | |
| | Aluminum | | — | — | — | 5 | — | — | — |
| | Hydroxide | | | | | | | | |
| | Polyamide | — | — | — | — | — | — | — | — |
| 2^{nd} | PET | 100 | 100 | 100 | 100 | 100 | 100 | 100 | 100 |
| | LOTADER | 20 | — | 20 | 10 | 20 | 40 | 20 | — |
| | AX 8900 | | | | | | | | |
| | ELVALOY | — | 10 | — | 10 | — | — | — | 30 |
| | PTW | | | | | | | | |
| | FUSABOND | — | — | — | — | — | — | — | — |
| | MB226D | | | | | | | | |
| | Titanium | — | 2 | — | — | — | 2 | 1 | 2 |
| | Oxide | | | | | | | | |
| | Aluminum | — | — | — | — | 5 | — | — | — |
| | Hydroxide | | | | | | | | |
| | Polyamide | — | — | — | — | — | — | — | — |
| 3^{rd} | PET | — | — | — | — | — | — | — | — |
| | LOTADER | — | — | — | — | — | — | — | — |
| | AX 8900 | | | | | | | | |
| | ELVALOY | — | — | — | — | — | — | — | — |
| | PTW | | | | | | | | |
| | FUSABOND | — | — | — | — | — | — | — | — |
| | MB226D | | | | | | | | |
| | Titanium | — | — | — | — | — | — | — | — |
| | Oxide | | | | | | | | |
| | Aluminum | — | — | — | — | — | — | — | — |
| | Hydroxide | | | | | | | | |
| | Polyamide | 100 | 100 | 100 | 100 | 100 | 100 | 100 | 100 |

Physical Properties
Twisted Test

| | | | | | | | | |
|---|---|---|---|---|---|---|---|---|
| Electric | Pass | Pass | Pass | Pass | Pass | Pass | Pass | Pass |
| Withstanding | | | | | | | | |
| (6 kV) | | | | | | | | |
| Electric | 23.4 | 20.4 | 21.5 | 24.3 | 18.7 | 24.5 | 25.6 | 20.8 |
| Breakdown | | | | | | | | |

Flexibility (Bending) Test

| | | | | | | | | |
|---|---|---|---|---|---|---|---|---|
| Electric | Pass | Pass | Pass | Pass | Pass | Pass | Pass | Pass |
| Withstanding | | | | | | | | |
| (3 kV) | | | | | | | | |
| Electric | 14.5 | 12.2 | 14.2 | 15.2 | 11.2 | 13.6 | 15.8 | 12.6 |
| Breakdown | | | | | | | | |

Heat Shock Test

| | | | | | | | | |
|---|---|---|---|---|---|---|---|---|
| Appearance | OK | OK | Ok | Ok | OK | OK | Ok | Ok |
| (Crack) | | | | | | | | |
| Electric | Pass | Pass | Pass | Pass | Pass | Pass | Pass | Pass |
| Withstanding | | | | | | | | |
| (3 kV) | | | | | | | | |
| Electric | 15.2 | 11.2 | 13.6 | 12.3 | 10.8 | 13.2 | 13.8 | 11.3 |
| Breakdown | | | | | | | | |

Thermal Shock Test (−20 to 150° C.)

| | | | | | | | | |
|---|---|---|---|---|---|---|---|---|
| Electric | Pass | Pass | Pass | Pass | Pass | Pass | Pass | Pass |
| Withstanding | | | | | | | | |
| (3 kV) | | | | | | | | |
| Electric | 14.8 | 12.0 | 13.2 | 14.8 | 10.2 | 13.5 | 14.5 | 12.2 |
| Breakdown | | | | | | | | |

### COMPARATIVE EXAMPLE

A comparative insulated wire was prepared in the same manner as mentioned in the above examples, but the raw materials that play the role of component (B) were not incorporated. The resulting comparative insulated wire was subject to Thermal Shock Test under the same operating conditions aforementioned. Cracking occurred to the comparative insulated wire after the test. In addition, the comparative insulated wire showed poor flexibility.

Although the present invention has been described with reference to preferred embodiments, workers skilled in the art will recognize that changes may be made in form and detail without departing from the spirit and scope of the invention.

1. A multi-layer insulated wire comprising a conductor strand and one or more insulating layers covering the conductor, wherein at least one insulating layer is made of a composition comprising:
(A) about 100 parts by weight of a thermoplastic polyester-series resin; and
(B) from about 1 to about 70 parts by weight of an ethylene-series polymer having at least one epoxy group and at least one acrylate group.

2. The multi-layer insulated wire according to claim 1, wherein the thermoplastic polyester-series resin (A) is selected from the group consisting of polyethylene terephthalate resins, polybutylene naphthalate resins, polycyclohexanedimethylene resins, polyethylene naphthalate resins, and mixtures thereof.

3. The multi-layer insulated wire according to claim 2, wherein the thermoplastic polyester-series resin (A) is selected from the group consisting of polyethylene terephthalate resins and mixture thereof.

4. The multi-layer insulated wire according to claim 1, wherein the ethylene-series polymer (B) is selected from the group consisting of ethylene/epoxy-(C₁-C₈-alkyl)acrylate polymers, ethylene/(C₁-C₈-alkyl)acrylate/epoxy-(C₁-C₈-alkyl)acrylate terpolymers, and mixtures thereof.

5. The multi-layer insulated wire according to claim 4, wherein the ethylene-series polymer (B) is selected from the group consisting of ethylene/epoxy-(C₁-C₄-alkyl)acrylate polymers, ethylene/(C₁-C₄-alkyl)acrylate/epoxy-(C₁-C₄-alkyl)acrylate terpolymers, and mixtures thereof.

6. The multi-layer insulated wire according to claim 1, wherein the composition comprises about 100 parts by weight of the thermoplastic polyester-series resin (A) and from about 1 to about 50 parts by weight of the ethylene-series polymer (B).

7. The multi-layer insulated wire according to claim 1, wherein the composition further comprises (C) one or more additives.

8. The multi-layer insulated wire according to claim 7, wherein the additives are selected from colorants, fillers, binders, coupling agents, aluminum hydroxides, and process additives.

9. The multi-layer insulated wire according to claim 1 further comprising a primer between the conductor and the one or more insulating layers.

10. The multi-layer insulated wire according to claim 1 further comprising an outermost layer.

11. The multi-layer insulated wire according to claim 10, wherein the outermost layer is made of a raw material selected from the group consisting of polyesters, polyamides, polyimides, polyphenylene sulfides, polyethersulfones, polysulfones, polycarbonates, fluoropolymers, and mixtures thereof.

12. The multi-layer insulated wire according to claim 1 further comprising a self-binding layer on its outside.

13. A transformer comprising the multi-layer insulated wire according to claim 1.

14. A process for preparing a multi-layer insulated wire comprising:
(a) providing a conductor strand; and
(b) applying onto the conductor strand a composition comprising about 100 parts by weight of (A) a thermoplastic polyester-series resin and from about 1 to about 70 parts by weight of (B) an ethylene-series polymer having epoxy and acrylate groups.

15. The process according to claim 14 wherein the composition further comprises (C) one or more additives.

16. The process according to claim 14, wherein the thermoplastic polyester-series resin (A) is selected from the group consisting of polyethylene terephthalate resins, polybutylene naphthalate resins, polycyclohexanedimethylene resins, polyethylene naphthalate resins, and mixtures thereof.

17. The process according to claim 14, wherein the ethylene-series polymer (B) is selected from the group consisting of ethylene/epoxy-(C₁-C₈-alkyl)acrylate polymers, ethylene/(C₁-C₈-alkyl)acrylate/epoxy-(C₁-C₈-alkyl)acrylate terpolymers, and mixtures thereof.

18. A process for preparing a multi-layer insulated wire comprising:
(a) providing a conductor strand;
(b) blending a composition comprising about 100 parts by weight of (A) a thermoplastic polyester-series resin and from about 1 to about 70 parts by weight of (B) an ethylene-series polymer having epoxy and acrylate groups, and, optionally, from (C) one or more additives; and
(c) applying a layer of the composition of step (b) onto the conductor strand.

19. The process according to claim 18, further comprising, prior to step (b), step (b₁) of forming a primer between the conductor and the layer of composition.

20. The process according to claim 18, wherein step (b) comprises blending a composition comprising the thermoplastic polyester-series resin (A) and the ethylene-series polymer having epoxy and acrylate groups (B) in an extruder, adding the additives to the composition, and forming the resulting composition into plastic pellets; and step (c) comprises feeding the plastic pellets into an extruder, extruding the plastic pellets to form a melt, and then coating the melt onto the conductor.

21. The process according to claim 18, wherein the thermoplastic polyester-series resin (A) is selected from the group consisting of polyethylene terephthalate resins, polybutylene naphthalate resins, polycyclohexanedimethylene resins, polyethylene naphthalate resins, and mixtures thereof.

22. The process according to claim 18, wherein the ethylene-series polymer (B) is selected from the group consisting of ethylene/epoxy-(C₁-C₈-alkyl)acrylate polymers, ethylene/(C₁-C₈-alkyl)acrylate/epoxy-(C₁-C₈-alkyl)acrylate terpolymers, and mixtures thereof.

23. The process according to claim 18, wherein step (b) is carried out at a temperature from about 200 to about 320° C., and step (c) at a temperature from about 200 to about 350° C.

24. The process according to claim 23, wherein step (b) is carried out at a temperature from about 220 to about 300° C., and step (c) at a temperature from about 200 to about 320° C.

25. The process according to claim 18, further comprising step (d) of forming an outermost layer on the multi-layer insulated wire obtained from step (c).

26. The process according to claim 25, wherein step (d) is carried out by extruding onto the multi-layer insulated wire a material containing a raw material selected from the group consisting of polyesters, polyamides, polyimides, polyphenylene sulfides, polyethersulfones, polysulfone, polycarbonates, fluoropolymers, and mixtures thereof.
